(19) United States
(12) Patent Application Publication
(10) Pub. No.: US 2007/0096411 A1
(43) Pub. Date: May 3, 2007

(54) Device for retaining a kneeling rider on a gliding board

(76) Inventors: Gary Leon Rempe II, Albuquerque, NM (US); James Landon Gilkey, Aztec, NM (US)

Correspondence Address: Gary L. Rempe II, 1007 Four Hills Ct Se, Albuquerque, NM, 87123, US

(21) Appl. No.: 11/265,044

(22) Filed: Nov. 2, 2005

(51) Int. Cl. A01D 75/00

(52) U.S. Cl. 280/32.5

(57) ABSTRACT

A retaining device (14) to secure a rider in a kneeling position to a gliding board (12) for use on snow. The retaining device (14) incorporates the riding performance of a conventional snowboard strap binding and includes a base (28) and a retention interface (46) configured to be coupled to the base (28) in a manner that provides the kneeling rider with the riding performance of a conventional snowboard strap binding. The retention interface may include one or more linkage members (33) that secure the kneeling rider to the gliding board (12). The retaining device (14) may be configured so that the base (28) engages regions of the retention interface (46) to which the linkage members (33) are attached to provide a feel similar to a conventional snowboard strap binding. The retaining device (14) may include a base-positioning mechanism (68) so as to enable the rider to adjust his or her position along a portion of the length of the gliding board (12) to customize his or her position according to snow conditions. The retaining device (14) may include three stabilizing features configured as front (20), medial side (18), and lateral side (19) stabilizers, supported by the base (28), and configured to maintain the rider's position on the gliding board (12). The retention interface (46) may include adjustable front (21a-21a) and rear (22a-22a) linkage systems to maintain sufficiently the kneeling rider's link to the base (28) in a manner that provides the kneeling rider with convenience and performance similar to a conventional snowboard strap binding.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### FIELD OF THE INVENTION

The present invention relates generally to the field of retaining a rider on a gliding board for use on snow, and relates more particularly to a device provided to secure a rider in a kneeling position to a gliding board for use on snow.

### BACKGROUND OF THE INVENTION

The most common method for binding a rider to a gliding board is established in the sport of snowboarding, which has become an increasingly popular sport, and even an Olympic event at the winter games. The most common type of snowboard binding includes one or more straps that extend across a standing rider's boot to secure the rider's boot and therefore foot to a binding baseplate. A conventional snowboard strap binding typically delivers a feel or performance many riders find desirable. More particularly, a conventional snowboard strap binding allows a standing rider's foot to roll laterally when riding by allowing the boot to roll relative to the binding.

Many people, however, find riding a gliding board in a standing position undesirable for several reasons. First, riding the gliding board in a standing position requires a great deal of balance and so can be intimidating and difficult to learn with many people never learning it. Second, when a rider, especially a beginner, catches an edge of the gliding board in the snow, the standing rider takes a hard fall that might seriously injure the rider's knees, spine, head or other body parts. Additionally, a standing rider's face is approximately five to six feet above the snow surface distancing the rider's face from the aesthetically pleasing sensation of moving through powdery snow. In contrast, a kneeling position, which places the rider lower to the ground, reduces the balance required by the rider, reduces risk of injury to the rider, and for many people may make the experience of gliding over snow more enjoyable.

A few devices for kneeling on pairs of skis exist, but many people may find it undesirable or awkward and difficult to control two separate skis simultaneously in a kneeling position. Since the kneeling rider is lower to the ground, the rider has less leverage when he or she leans to turn in comparison with a standing rider, thus many people find turning two separate skis in a kneeling position difficult. Also, some people may find keeping two skis in the conventional parallel position while negotiating terrain using only their knees difficult as the skis have a tendency to drift apart, which could produce serious injury.

Other sledding and skiing devices exist that contain features that are merely a knee-pocket. Some people may find that the knee-pockets do not sufficiently bind the rider to the sledding or skiing device to provide enough control to turn and stop quickly. In large part this is because a knee-pocket does not provide the features necessary to bind sufficiently the rider's lower body to the sledding or skiing device. Lifting and torsional forces during riding can cause separation between the knee and the knee-pocket causing a loss of control.

Additional devices exist that are simply a sled with a strap across the top of the sled to provide a loose linkage of rider to sled. Since these straps are attached directly to the top of the sled wall, which is typically above the rider's knees, the strap typically rides just above the knees and consequently some people may find it does not provide enough control or bind the rider securely enough to the sled to ensure the rider's safety. In other cases the strap is attached to the side of a more board-like device, but even in these instances, because the strap is attached to the side of the board-like device, the strap is not secured directly against the sides of the legs, and so instead proceeds at a sloping angle from the top of the rider's thigh to the side of the board-like device. This leaves the sides of the legs free to slip from side to side.

Other devices exist described as sport knee boots that are configured to be worn all the time while skiing on knees and are configured specifically to be attached to a conventional ski binding and used with two separate skis. Many people may find wearing a knee boot both when attached and when not attached to skis uncomfortable and inconvenient. The knee boot also is configured specifically for use with two separate skis, which as mentioned above, many people may find makes it awkward, difficult, and unsafe for the rider.

Controlling a gliding board in a kneeling position down a snow-covered hill involves balance and control of movement. When steering down a slope, the rider leans in various directions in order to control the direction of the movement of the gliding board. Specifically, as the rider leans, his or her movements must be transmitted from the rider to the gliding board in order to maintain control. For example, when the rider leans to the right, the movement causes the gliding board to tilt accordingly turning in the direction of the lean. The motion corresponding to the direction of the lean of the rider is transmitted through the retaining device to the gliding board to effect turning or braking. Therefore, it is extremely important that the retaining device used by the rider have sufficient ability to transfer such leaning motion to the gliding board.

It is an object of the present invention to provide an improved device to secure a rider in a kneeling position to a gliding board for use on snow.

### SUMMARY OF THE INVENTION

One embodiment of the present invention is directed to a retaining device to secure a rider in a kneeling position to a gliding board for use on snow. The retaining device comprises a base that supports a portion of the rider's leg and a retention interface. The base has a front end and rear end and is configured to be attached to the gliding board in a manner so as to support sufficiently the rider. The retention interface includes one or more linkages that can be engaged and disengaged using a linkage engagement feature so as to enable exit from the retaining device when disengaged and so as to maintain sufficiently the portion of the rider's leg on the base when engaged.

A further embodiment of the present invention is directed to a retaining device to couple a rider in a kneeling position to a gliding board for use on snow. The retaining device comprises a base that supports a portion of the rider's leg and a retention interface. The base has a front end and rear end and is configured to be attached to the gliding board in a manner so as to support sufficiently the rider. The base includes a base-positioning mechanism so as to enable the rider to move the base through a plurality of lockable positions so that the rider may adjust his or her position along a portion of the length of the gliding board. The retention interface includes two linkage systems to secure the portion of the rider's leg to the base. The two linkage systems are adjustable lengthwise, are adjustably attached to opposite sides of the base, and are secured over the portion of the rider's leg by mating using an incrementally adjustable linkage engagement feature. For additional rider support, a medial side stabilizer, a lateral side stabilizer, and a front stabilizer are attached to the base.

Another embodiment of the present invention is directed to a retaining device to bind a rider in a kneeling position to a gliding board for use on snow. The retaining device comprises a retention interface and a base. The base has a front end and a rear end, and an upper portion and a bottom portion. The base is configured to be attached to the gliding board in a manner so as to support sufficiently a portion of the rider's leg. The upper portion of the base is configured at an incline with respect to the bottom portion of the base sloping from the rear end to the front end. The retention interface includes one or more linkage members that can be secured and released using a linkage engagement feature so as to enable exit from the retaining device when released, and so as to maintain sufficiently the portion of the rider's leg on the base when secured.

A further embodiment of the present invention is directed to a retaining device to secure a rider in a kneeling position to a gliding board for use on snow. The retaining device comprises a base including an upper portion and a bottom portion with the bottom portion configured to engage the gliding board. The retaining device further includes at least one linkage member supported along a side of the base, the linkage member being adapted to engage at least one linkage engagement feature supported along the side of the base opposing the side of the base supporting the linkage member. The linkage engagement feature is movable between an open position to release the linkage member and at least one closed position to secure the linkage member. The retaining device further includes a medial side and a lateral side with a portion of the rider's leg placed between the medial and lateral sides.

Another embodiment of the present invention is directed to a retaining device to secure a rider in a kneeling position to a gliding board for use on snow. The retaining device comprises a base that includes an upper portion and a bottom portion with the bottom portion configured to engage the gliding board. The upper portion of the base is configured at an incline with respect to the bottom portion of the base sloping from the rear end to the front end. The retaining device further includes at least one linkage member supported along a side of the base, the linkage member being adapted to engage at least one linkage engagement feature supported along the side of the base opposing the side of the base supporting the linkage member. The linkage engagement feature is movable between an open position to release the linkage member and at least one closed position to secure the linkage member. The retaining device further includes a medial side and a lateral side with a portion of the rider's leg placed between the medial and lateral sides.

A further embodiment of the present invention is directed to a retaining device to secure a rider in a kneeling position to a gliding board for use on snow. The retaining device comprises a base that supports a portion of the rider's legs and a retention interface. The base has a front end and rear end and is configured to be attached to the gliding board in a manner so as to support sufficiently the rider. The retention interface includes one or more linkages that can be engaged and disengaged using a linkage engagement feature so as to enable exit from the retaining device when disengaged and so as to maintain sufficiently the portion of rider's legs on the base when engaged.

Another embodiment of the present invention is directed to a retaining device to couple a rider in a kneeling position to a gliding board for use on snow. The retaining device comprises a base that supports a portion of the rider's legs and a retention interface. The base has a front end and rear end and is configured to be attached to the gliding board in a manner so as to support sufficiently the rider. The base includes a base-positioning mechanism so as to enable the rider to move the base through a plurality of lockable positions so that the rider may adjust his or her position along a portion of the length of the gliding board. The retention interface includes two linkage systems to secure the portion of the rider's legs to the base. The two linkage systems are adjustable lengthwise, are adjustably attached to opposite sides of the base, and are secured over the portion of the rider's legs by mating using an incrementally adjustable linkage engagement feature. For additional rider support, a medial side stabilizer, a lateral side stabilizer, and a front stabilizer are attached to the base.

A further embodiment of the present invention is directed to a retaining device to bind a rider in a kneeling position to a gliding board for use on snow. The retaining device comprises a retention interface and a base. The base has a front end and a rear end, and an upper portion and a bottom portion. The base is configured to be attached to the gliding board in a manner so as to support sufficiently a portion of the rider's legs. The upper portion of the base is configured at an incline with respect to the bottom portion of the base sloping from the rear end to the front end. The retention interface includes one or more linkage members that can be secured and released using a linkage engagement feature so as to enable exit from the retaining device when released, and so as to maintain sufficiently the portion of the rider's legs on the base when secured.

Another embodiment of the present invention is directed to a retaining device to secure a rider in a kneeling position to a gliding board for use on snow. The retaining device comprises a base including an upper portion and a bottom portion with the bottom portion configured to engage the gliding board. The retaining device further includes at least one linkage member supported along a side of the base, the linkage member being adapted to engage at least one linkage engagement feature supported along the side of the base opposing the side of the base supporting the linkage member. The linkage engagement feature is movable between an open position to release the linkage member and at least one closed position to secure the linkage member. The retaining device further includes a medial side and a lateral side with a portion of the rider's legs placed between the medial and lateral sides.

A further embodiment of the present invention is directed to a retaining device to secure a rider in a kneeling position to a gliding board for use on snow. The retaining device comprises a base that includes an upper portion and a bottom portion with the bottom portion configured to engage the gliding board. The upper portion of the base is configured at an incline with respect to the bottom portion of the base sloping from the rear end to the front end. The retaining device further includes at least one linkage member supported along a side of the base, the linkage member being adapted to engage at least one linkage engagement feature supported along the side of the base opposing the side of the base supporting the linkage member. The linkage engagement feature is movable between an open position to release the linkage member and at least one closed position to secure the linkage member. The retaining device further includes a medial side and a lateral side with a portion of the rider's legs placed between the medial and lateral sides.

### BRIEF DESCRIPTION OF THE DRAWINGS

The foregoing and other objects and advantages will be appreciated more fully from the description that follows, with reference to the annexed drawings illustrating, by way of non-limiting example, how the invention can be embodied, and in which:

FIG. 1 is a perspective view of a retaining device according to one illustrative embodiment of the invention;

FIG. 2a is a side view of the retaining device of FIG. 1;

FIG. 2b is a partial cross-section view of the side of the retaining device of FIG. 1 taken along the cross-sectional line 2b-2b of FIG. 1;

FIG. 3 is a top view of the retaining device of FIG. 1;

FIG. 4 is an exploded view of an adjustable first linkage member of the device of FIG. 1;

FIG. 5 is an exploded view of a base-attachment mechanism of the device of FIG. 1;

FIG. 6a is an exploded side view in default position of a ratchet-type fastener of the device of FIG. 1;

FIG. 6b is an exploded side view with a ratchet lever raised of the ratchet-type fastener of the device of FIG. 1;

FIG. 6c is an exploded side view illustrating the movement of a ratchet release of the ratchet-type fastener of the device of FIG. 1;

FIG. 6d is an exploded perspective view of the ratchet-type fastener of the device of FIG. 1;

FIG. 7 is a partial cross-sectional rear view of the device of FIG. 1 taken along the cross-sectional line 7-7 of FIG. 3;

FIG. 8 is an exploded partial cross-sectional rear view of the device of FIG. 1 taken along the cross-sectional line 8-8 of FIG. 3;

FIG. 9a is an exploded view of the quick-release mechanism of the device of FIG. 1;

FIG. 9b is a cross-sectional view of the quick-release mechanism of the device of FIG. 1 taken along the cross-sectional line 9b-9b of FIG. 9a; and

FIG. 10 is a perspective view of a retaining device according to one illustrative embodiment of the invention slightly modified to support two legs therein.

### DETAILED DESCRIPTION

The present invention is directed to an improved device for retaining a kneeling rider on a gliding board for use on snow that incorporates the convenience and riding performance of a conventional snowboard strap binding. This may be accomplished with a retaining device that includes a base, and a retention interface that includes one or more linkage members, and is configured to be coupled to the base in a manner similar to a conventional snowboard strap binding. Thus, when the retention interface is coupled to the base, the retaining device operates like, and provides the kneeling rider with a performance and feel, similar to a conventional snowboard strap binding. Although the base and the retention interface may be advantageously employed together, the present invention is not limited in this respect, as each of these aspects of the present invention can also be employed separately. For example, the base may be employed to directly engage one or both of the rider's legs, rather than engage one or both of the rider's legs through a separate interface. Similarly, the retention interface may be employed with numerous types of bases, and is not limited to use with the illustrative embodiments disclosed herein.

The retaining device may be configured so that the base engages one or more regions of the retention interface to provide a feel similar to that of a conventional snowboard strap binding. In this regard, each of the base-engagement regions can include base-attachment mechanisms that are positioned relative to each other so that forces exerted on the linkage members are transmitted through the base-attachment mechanisms in a manner that achieves a desired feel. Such a configuration may facilitate the transmission of forces exerted on the retention interface to the base in a manner similar to a conventional snowboard strap binding in which forces are transmitted directly to a binding baseplate through a strap mounted directly to the baseplate.

In one embodiment, the retaining device may employ a four point engagement between the retention interface and the base. Such an arrangement may substantially reduce, if not eliminate, movement between the retention interface and the base so that movement of the portion of the rider's leg relative to the base may be controlled by the manner in which the portion of the rider's leg is secured to the base through the retention interface. The arrangement causes the retaining device to have a performance and feel similar to a conventional snowboard strap binding by transmitting forces exerted by a rider to four points of engagement similar to the strap attachment points of a conventional snowboard strap binding. In this regard, corresponding pairs of linkage members may be arranged along opposing sides of the portion of the rider's leg. It is to be appreciated, however, that other embodiments of the retaining device do not employ a four-point engagement configuration.

In one embodiment, the retention interface may be configured with multiple linkage members to deliver a kneeling rider with a desired feel associated with conventional snowboard strap bindings. In this regard, the retention interface may include front and rear linkage systems that each may include one or more linkage members that are arranged to extend across a portion of the rider's leg. The linkage systems may be attached to regions of the base adjacent the base-attachment mechanisms so that forces exerted by the rider on the linkage systems are transmitted directly to regions of the retaining device in a manner similar to a conventional snowboard strap binding. It is to be understood, however, that other embodiments do not use multiple linkage members. And other embodiments do not attach the linkage systems adjacent the base-attachment mechanisms. Furthermore, other embodiments utilize base-attachment mechanisms that are not uniform in height. Still other embodiments utilize base-attachment mechanisms that are uniform in height.

In one embodiment, the base may include a base-positioning mechanism that may include two or more lockable positions along its length. Using the base-positioning mechanism, the rider can advantageously adjust his or her position forward or backward along a portion of the length of the gliding board to improve the performance of the gliding board. Typically, this would mean a forward position for harder-packed snow, so that the edge of the gliding board can more effectively carve into the snow surface, and a backward position for powdery snow, so that the front of the gliding board can ride up and better float over light snow. Since the rider is kneeling, he or she cannot lean backward or forward as much as a standing rider to lift or dive, respectively, the front of the gliding board. Consequently, a mechanism for adjusting the rider's position along a portion of the length of the gliding board is especially advantageous for a kneeling rider. While advantageous, other embodiments do not utilize a base-positioning mechanism. Still other embodiments enable adjustment of the rider's position along a portion of the length of the gliding board using any suitable configuration to achieve a variety of performance and convenience characteristics.

In one embodiment, two pairs of linkage members may be utilized and the pairs of linkage members may be adapted to engage each other utilizing a linkage engagement feature that can be moveable between an open position to release the pair of linkage members and at least one closed position to secure the pair of linkage members in a manner similar to a conventional snowboard strap binding.

In one embodiment, one or more linkage members are cushioned to enhance their comfort. In other embodiments, no linkage members are cushioned.

In one embodiment, the linkage engagement feature may be a ratchet-type fastener. In another embodiment, the linkage engagement feature may be hook and loop. Other embodiments of the linkage engagement feature do not utilize either a ratchet-type fastener or hook and loop. In one embodiment, the linkage engagement feature is supported by a linkage member. In other embodiments, the linkage engagement feature is not supported by a linkage member.

In one embodiment, front and rear linkage systems, and front, medial side, and lateral side stabilizers may be utilized that fit snugly against the portion of the rider's leg, but do not prevent the portion of the rider's leg from rolling therein. Consequently, the configuration does not inhibit roll within the retaining device in a manner similar to a conventional snowboard strap binding. This configuration also effectively transmits the direction of lean of the rider through the retaining device to the gliding board to effect turning or braking in a manner similar to a conventional snowboard strap binding. It is to be appreciated, however, that while advantageous, other embodiments may not employ front and rear linkage systems. It is also to be appreciated that other embodiments may employ linkage-member configurations without the addition of stabilizing features.

In one embodiment, a suspension system may be included that is layered between the base and the gliding board and may be available to the rider in varying degrees of stiffness including, but not limited to: soft, medium, and hard to allow the rider to customize the retaining device to suit his or her riding style. For instance, a more advanced or aggressive rider may prefer a suspension system with more stiffness than a less advanced or passive rider since the stiffer suspension system can be more responsive to the motion of the rider's leans. Other embodiments do not utilize a suspension system.

In one embodiment, a medial side stabilizer, a lateral side stabilizer, and a front stabilizer may be included that are supported by the base so as to substantially maintain the rider's side and front positions on the base. Other embodiments may not include stabilizers. Further embodiments may utilize one or more stabilizers.

In one embodiment, one or more stabilizer cushion members may be demountably attached to regions of the stabilizers that engage the rider to provide a more comfortable ride. In other embodiments none of the stabilizer cushion members may be demountably attached. Further embodiments may not utilize stabilizer cushion members.

In one embodiment, one or more of the base cushion members may be demountably attached to the base. In other embodiments, no base cushion member may be demountably attached to the base. Other embodiments may not utilize a base cushion member.

In one embodiment, the base includes an upper portion that is configured to form a substantially flat surface from the rear end toward the front end of the base. In other embodiments, however, the upper portion is configured at an acute angle with respect to the bottom portion of the base that may range from 5 to 35 degrees so that the upper portion forms an incline from the rear end toward the front end of the base.

In one embodiment, the retaining device may be configured to accommodate both of the rider's legs therein. In other embodiments, the retaining device may be configured for use as a paired device.

In one embodiment, the base may be configured to accommodate an accumulation of snow, ice or other debris at the front end of the base. In other embodiments, the base may not accommodate an accumulation of snow, ice or other debris at the front end of the base.

In one embodiment, the retaining device may be configured to support and retain a portion of one or both of the kneeling rider's legs. In other embodiments, however, the retaining device may be configured specifically to support and retain a portion or whole of one or both of the kneeling rider's knees, thighs, legs, calves and the like, or any combination thereof.

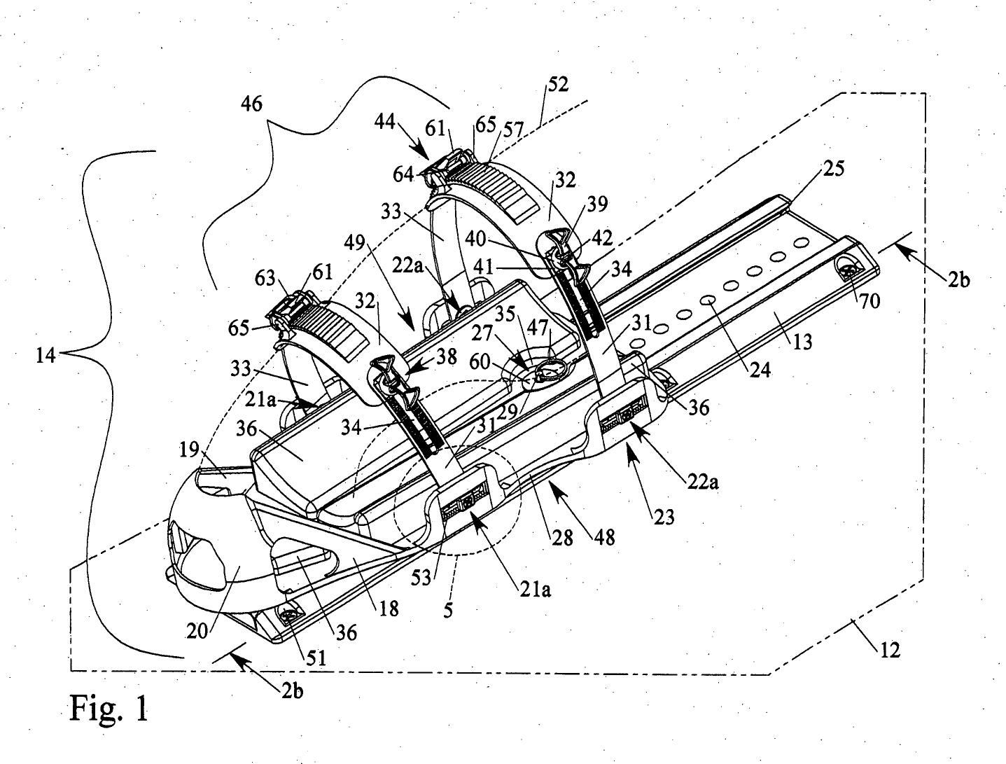

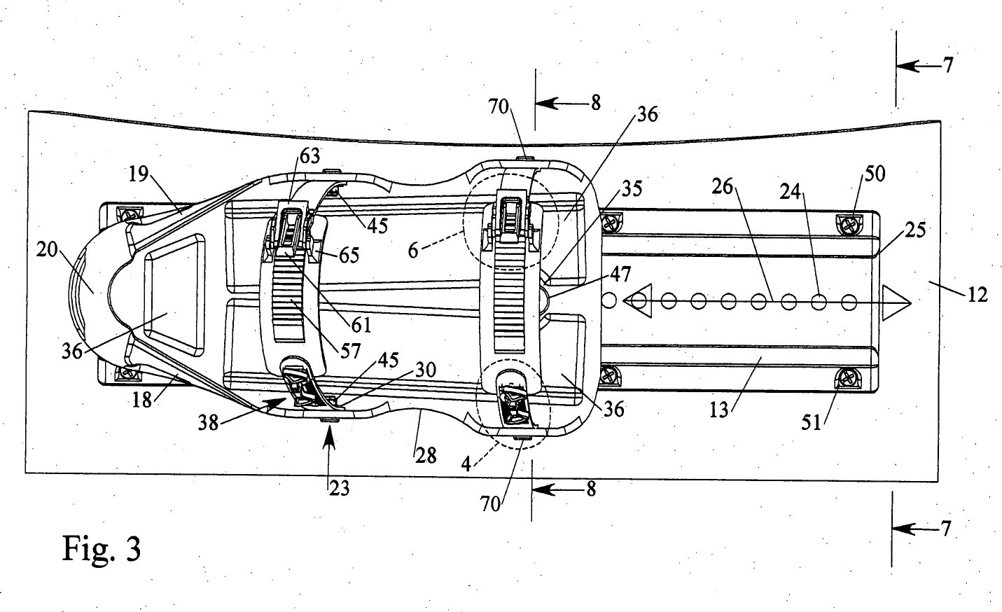

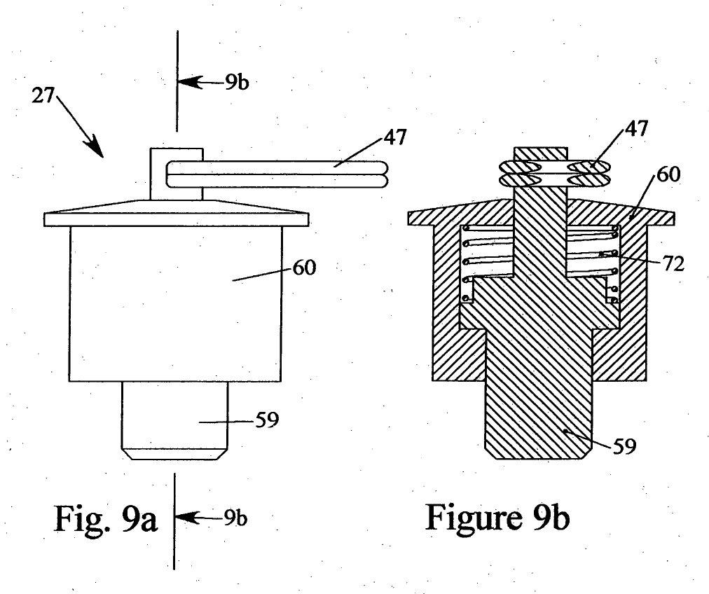

In one illustrative embodiment shown in FIGS. 1-9, the retaining device 14 includes a base 28 and a retention interface 46 that is configured to cooperate with the base 28 to secure a portion of a rider's leg 52 to a gliding board 12 along a longitudinal axis 26 extending through the entire length of the retaining device 14. The portion of the rider's leg 52 extends along the longitudinal axis 26 when the rider is retained by the retaining device 14. The retaining device 14 employs an engagement arrangement between the retention interface 46 and the base 28 in a manner similar to a conventional snowboard strap binding. In this regard, in one embodiment the retention interface 46 employs an engagement arrangement in which the retention interface 46 is attached to the base 28 in the region of each base-attachment mechanism 23.

For example, when the retaining device 14 employs two pairs of linkage members, a four point engagement (two points on each side of the base 28 with each point in a region of one of the base-attachment mechanisms 23) is provided between the retention interface 46 and the base 28 to provide the feel of a conventional snowboard strap binding. It is to be appreciated, however, that the retaining device 14 may be configured to employ any number of engagement points greater than or less than four engagement points. Furthermore, in other embodiments of the invention, the retaining device 14 does not have engagement points aligned with base-attachment mechanisms. Although the base 28 and the retention interface 46 may be advantageously employed together, this particular embodiment of the retaining device 14 is not limited in this respect, as the base 28 and the retention interface 46 also can be employed separately. For example, the base 28 may be employed to directly engage the portion of the rider's leg 52, rather than engage the portion of the rider's leg 52 through a separate interface.

As indicated above, the retention interface 46 is not limited to use with any particular base and, therefore, is not limited to the use of any particular mating features for engaging with a base. Notwithstanding the foregoing, the retention interface 46 will be described below in connection with a retaining device 14 that employs an attachment configuration wherein base attachment mechanisms 23 are provided in regions where the retention interface's linkage members are attached to the base. Thus, for a retention interface 46 including two linkage systems, a four-point attachment configuration is employed for the retaining device 14.

In the illustrative embodiment shown in FIGS. 1-9, two linkage systems, a front linkage system 21a-21a, and a rear linkage system 22a-22a, are employed to secure the portion of the rider's leg 52 to base 28 in a manner similar to a conventional snowboard strap binding. Each linkage system, front 21a-21aand rear 22a-22a, includes: a first linkage member 31, a second linkage member 32, a third linkage member 33, and a ratchet-type fastener 44. It is to be understood, however, that the present invention is not limited to the use of any particular number or type of linkage member, as numerous other linkage-member arrangements, including arrangements with a single linkage member or more than two linkage members, may be employed for securing the portion of the rider's leg 52 to the retention interface 46, and consequently to the gliding board 12 when the retention interface 46 is coupled to the base 28. Thus, as used herein, the term linkage member is intended to indicate any structure that passes over a surface, or combination of surfaces, of the thigh, hip, knee, waist, leg, calf and the like, and performs this attachment function including straps, web-like structures, strings, laces, bails and the like.

In the illustrative embodiment shown in FIGS. 1-9, the linkage members are not cushioned. It is to be understood, however, that this is not a limitation of all embodiments of the invention, and any suitable linkage member configuration may be employed in accordance with other embodiments including, but not limited to, configurations in which the linkage members are cushioned with any suitable material or combination of materials such as ethylene vinyle acetate, leather, silicon gel and the like, to achieve any desired performance characteristics including, but not limited to, increased comfort, decreased weight, increased strength and the like. Consequently, the configuration illustrated in this embodiment should not be construed as limiting.

The linkage members may be formed from a plastic material, such as a molded polyurethane, a molded carbon-reinforced polyurethane and the like. It is to be understood, however, that the linkage members can be formed from any suitable material.

As indicated above, in one embodiment, each linkage system, front 21a-21a and rear 22a-22a, includes: a first linkage member 31, a second linkage member 32, a third linkage member 33, and a ratchet-type fastener 44. The ratchet-type fastener 44 is one embodiment of a linkage engagement feature. As indicated above, the retention interface 46 may employ mating features having any configuration suitable for mating with corresponding base attachment mechanisms on the base. In one embodiment, each first and third linkage member is attached to the base 28 employing a base-attachment mechanism 23 that enables the attached position of the linkage member to be adjusted along the length of the base 28. The base-attachment mechanism 23 includes a horizontal slot 55, female striations 53, and the striated engagement mechanism 54. Striated engagement mechanism 54 has male striations on its underside facing and cooperating with the female striations 53, to engage and disengage as screw 50 is tightened or loosened, respectively, by the rider into nut 45.

The base-attachment mechanism 23 in the illustrative embodiment shown in FIGS. 1-9 is integrally formed with the base 28 from one or more materials. In other embodiments, however, the base-attachment mechanism 23 is employed as one or more unique pieces made from one or more materials and affixed to base 28 using any suitable attachment configuration such as screws, adhesive, welding, rivets, bolts and the like to provide any desired performance characteristics. Consequently, the configuration illustrated in this embodiment should not be construed as limiting.

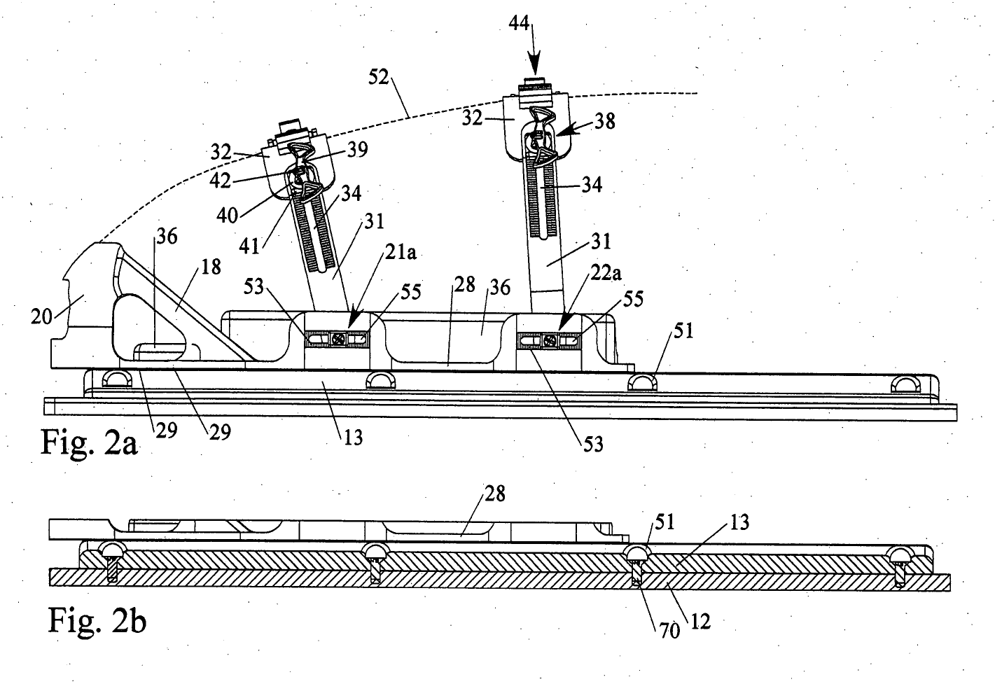

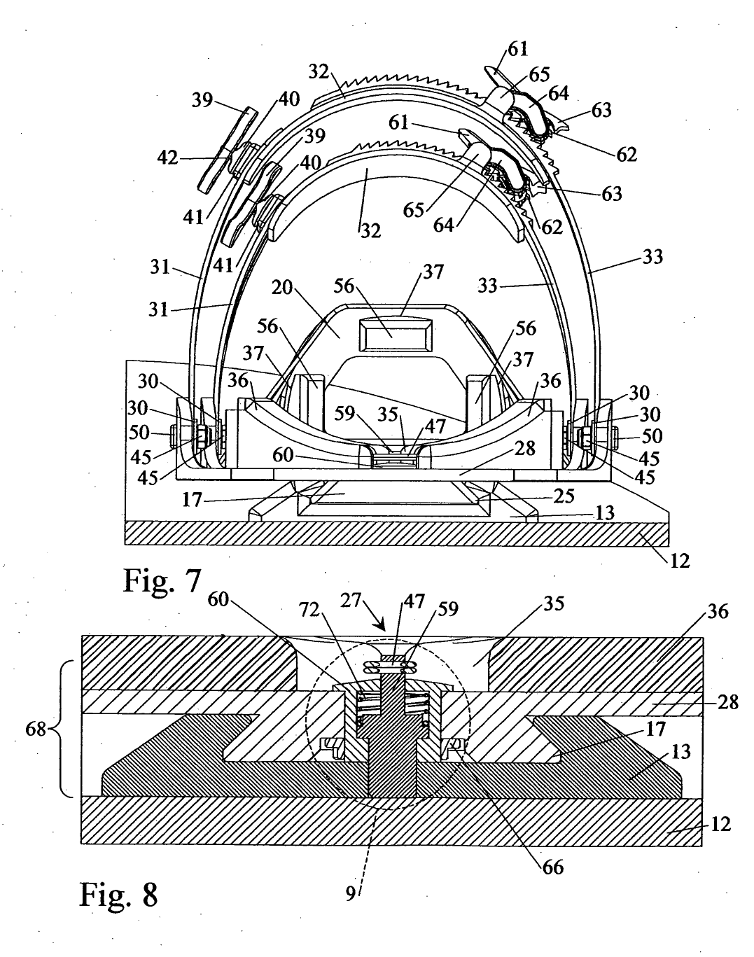

The base-attachment mechanism 23 enables the rider to advantageously adjust the position of each linkage system along the length of the base 28. It is to be understood that while advantageous, the base-attachment mechanism 23 is not limited to this configuration. Any suitable configuration may be employed for the base-attachment mechanism 23 from something as simple as a screw, rivet and the like that does not enable adjustment along the length of the retaining device 14, to something more complex such as a finger-operated quick-release mechanism that does not require a tool. Furthermore, as shown in FIGS. 2a and 7, the base-attachment mechanisms 23 are all of equal height. It is to be understood, however, that the base-attachment mechanisms are not limited to the configuration illustrated in this embodiment as other configurations are possible.

In the illustrative embodiment shown in FIGS. 1-9, the retaining device 14 includes a medial side 48 located on the same side of the base 28 as a medial side stabilizer 18, a lateral side 49 located on the same side of the base 28 as a lateral side stabilizer 19, a front end located on the same end of the base 28 as a front stabilizer 20, and a rear end located on the end of the base 28 that opposes the front end of the base 28.

As illustrated, in one embodiment, one pair of base-attachment mechanisms 23 is located along opposing sides of the base 28 and substantially near a middle region of the base 28 (the middle region of the base 28 defined as half the distance between the front end of base 28 and the rear end of base 28) so as to be in the same regions where the front linkage system 21a-21a is attached to base 28. A second pair of base-attachment mechanisms 23 is located along the opposing sides of base 28 and substantially in the same region along the longitudinal axis 26 as that of well 35, so as to be in the same regions where the rear linkage system 22a-22a is attached to base 28. The particular configuration and/or location of the base-attachment mechanisms 23, however, while advantageous, is not a limitation of all embodiments of the present invention as any suitable configuration or arrangement may be implemented to mount the linkage systems, front 21a-21a and rear 22a-22a, to the base 28 including, but not limited to, configurations that do not utilize base-attachment mechanisms.

As illustrated, in one embodiment, the base-attachment mechanisms 23 are positioned along the sides of the portion of the rider's leg 52 and so ensure the linkage systems, front 21a-21a and rear 22a-22a, are secured on the sides of the portion of the rider's leg 52 to transmit the motion of rider leans to the gliding board 12 in a manner that is similar to a conventional snowboard strap binding. It is to be understood, however, that while the above-mentioned configuration is advantageous, the base-attachment mechanisms 23 and linkage systems, front 21a-21a and rear 22a-22a, may be located in any desirable locations along the base 28.

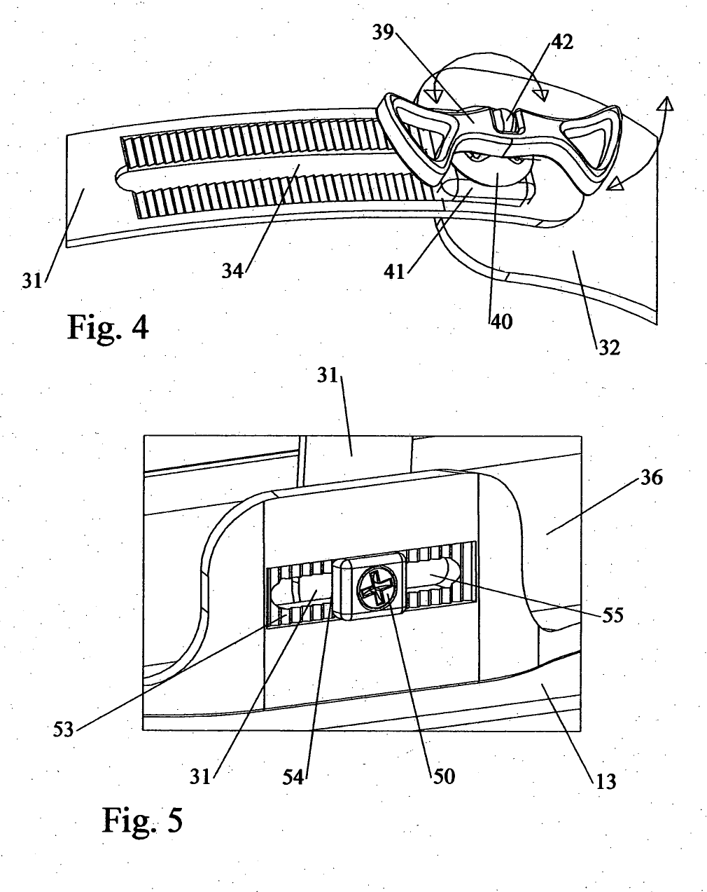

In the illustrative embodiment of FIG. 4, a linkage-length adjustment mechanism 38 may be included that enables the rider advantageously to adjust the length of the first linkage member 31 without using a tool. In one embodiment, the linkage-length adjustment mechanism 38 includes the first linkage member 31 that includes a striated slot 34 and an engagement component 41 that is striated on its underside so as to disengage and engage, utilizing a linkage-holding pin 42, to which the linkage-release members 39 are hinged. As the rider raises and lowers the linkage-release members 39, the engagement component 41 is disengaged and engaged, respectively, as the striations of the engagement component 41 cooperate with the striations of slot 34 to mate. In one embodiment, the linkage-holding pin 42 passes through a circular spacer 40, the engagement component 41, and is pivotably attached to the second linkage member 32 using a rivet or other suitable attachment configurations.

It is to be understood that the linkage-length adjustment mechanism 38 is not limited to the configuration described in this embodiment as any suitable configuration may be employed to achieve any desired performance characteristics including something as basic as having two or more attachment points as an integral part of the linkage member to enable length adjustment. In other embodiments, the linkage-length adjustment mechanism 38 does not protrude from the upper surface of the first linkage member 31 when engaged so as to make the configuration more streamline so that the rider does not accidentally bump the configuration and so the configuration better deflects snow, ice and other debris. Consequently, the particular configuration illustrated in this embodiment should not be construed as limiting.

In the illustrative embodiment shown in FIGS. 1-9, the ratchet-type fastener 44 is attached to the second linkage member 32 using a rivet or other suitable attachment configurations. The ratchet-type fastener 44 engages with striations on the tongue of the third linkage member 33. In a manner similar to a conventional snowboard strap binding, tightening the second 32 and third 33 linkage members involves a relative sliding motion between the two linkage members by the kneeling rider, with one of the linkage members 32 sliding between the portion of the rider's leg 52 and the other linkage member 33, to advantageously enable incremental adjustment of the linkage systems, front 21a-21a and rear 22a-22a, by the kneeling rider so that the rider can achieve a desired feel in a manner similar to a conventional snowboard strap binding.

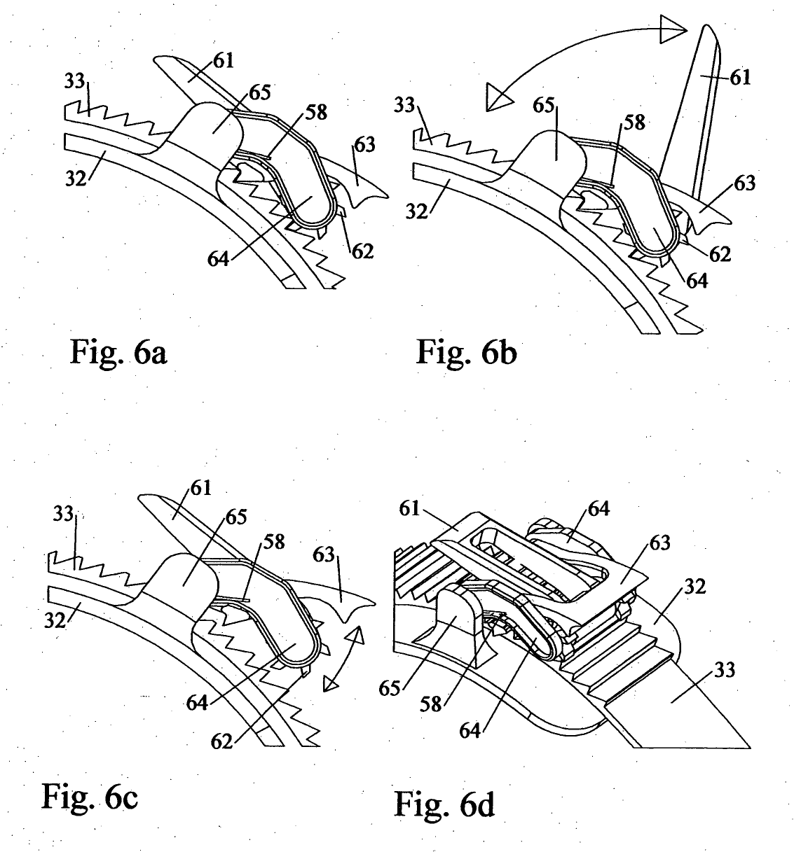

In the illustrative embodiment of FIGS. 6a-6d, the ratchet-type fastener 44 may advantageously include a ratchet lever 61 with ratchet teeth 62 molded to its toothed linkage-member-engagement end. As the ratchet lever 61 is raised by the rider, its ratchet teeth mate and rotate over the striations on the third linkage member 33 and in the process tighten incrementally the linkage system so that the kneeling rider can achieve a desired feel similar to a conventional snowboard strap binding. A ratchet release 63 engages with the third linkage member 33 striations when in its default position. The ratchet release's default position is flexibly maintained by ratchet spring 58 so as to prevent the ratchet-type fastener 44 from slipping and therefore loosening during tightening. In one embodiment, the ratchet spring 58 is formed from a spring steel, although it may be formed from any suitable material including, but not limited to, stainless steel.

As illustrated, the ratchet release 63 linkage-member-engagement end can be advantageously raised by the rider to disengage from the third linkage member 33 so as to enable the quick release of the linkage system from the portion of the rider's leg 52 to facilitate an exit by the rider from the linkage system in a manner similar to a conventional snowboard strap binding. As is to be appreciated, the ratchet release 63 provides a rider with the ability to readily disengage from the retaining device 14, which may be very convenient. For example, the rider may wish to disengage the retaining device 14 when advancing along a slope or in a lift line. To do so, the rider simply pulls upward on the raised end of ratchet release 63, which then causes the opposite end of ratchet release 63 to rise and disengage from the third linkage member 33. The rider then pulls the third linkage member 33 out from the ratchet-type fastener 44. The rider repeats this action with the other linkage system and the rider can then exit the retaining device in a manner similar to a conventional snowboard strap binding.

As illustrated, in one embodiment in particular, the ratchet release 63 and ratchet lever 61 are pivotably mounted to ratchet hinges 64 that are hinged to ratchet mounts 65 that are molded to second linkage member 32. It is to be understood that any suitable configuration may be employed for the ratchet-type fastener 44 to achieve any desired performance characteristics including, but not limited to, lighter weight, increased strength, greater operational convenience, and/or better deflection of snow, ice, and debris. Consequently, the ratchet-type fastener 44, while advantageous, is not limited to the particular configuration illustrated in this embodiment.

The ratchet-type fastener 44 may be formed from any suitable material or combination of materials to achieve a desired combination of strength, stiffness, weight and the like. For example, ratchet-type fastener 44 may be formed from one or more substantially rigid materials, such as aluminum, magnesium, titanium, carbon-reinforced plastic, stainless steel, polycarbonate, thermoplastic polyurethane and the like. It is to be appreciated, however, that the particular material or combination of materials employed for the ratchet-type fastener 44 may be chosen to achieve any desired performance characteristics.

The front 21a-21a and rear 22a-22a linkage systems, and front 20, medial side 18, and lateral side 19 stabilizers fit snugly against the portion of the rider's leg 52, but do not prevent the portion of the rider's leg 52 from rolling therein. Consequently, this advantageous configuration does not inhibit roll within the retaining device 14 in a manner similar to a conventional snowboard strap binding. It is to be understood, however, that while advantageous, the retaining device 14 is not limited to the configuration illustrated in this embodiment and any suitable configuration may be employed.

The advantageous configuration of the front 21a-21a and rear 22a-22a linkage systems, and front 20, medial side 18, and lateral side 19 stabilizers in the illustrative embodiment shown in FIGS. 1-9 effectively transmits the direction of lean of the rider through the retaining device 14 to the gliding board 12 to effect turning or braking in a manner similar to a conventional snowboard strap binding. It is to be appreciated, however, that while advantageous, other embodiments do not employ front and rear linkage systems. It is also to be appreciated that other embodiments employ linkage systems without stabilizing features. Similarly, one or more linkage systems may be employed with numerous types of bases, and are not limited to use with the illustrative embodiments disclosed herein.

In the illustrative embodiment shown in FIGS. 1-9, a base-positioning mechanism 68 is included, which in this embodiment includes the base rail 17, gliding-board rail 13, and quick-release mechanism 27. The base rail 17 is integrally formed with the base 28 from one or more materials. The base rail 17 is configured to mate with gliding-board rail 13 by sliding into the gliding-board rail mating feature 25. The base rail 17 and therefore the base 28, when mated to the gliding-board rail 13, can then be moved back and forth advantageously along the length of the gliding-board rail 13 so that the rider can adjust his or her position along a portion of the length of the gliding board 12 when the gliding-board rail 13 is affixed to the gliding board 12. It is to be understood that the base rail 17 does not have to be integrally formed with the base 28 as illustrated, and that the base rail 17 can be of any suitable configuration including, but not limited to, it being formed separately from the base 28. It is also to be understood that the base rail 17, when formed separately from the base 28, can be affixed to the base 28 using any suitable attachment configuration including adhesives, rivets, welding, bolts and the like.

The base 28 and base-positioning mechanism 68 will be subjected to significant lifting and torsional forces during riding and should be relatively lightweight to enhance rider performance. Thus, it may be desirable to form them from a relatively strong and lightweight material or combination of materials. For example, base 28 and the base-positioning mechanism 68 may be formed from carbon-reinforced plastic, glass-reinforced nylon, carbon-fiber reinforced nylon, polycarbonate, magnesium, stainless steel, titanium, hardened steel, hardened aluminum and the like to withstand the anticipated forces and performance requirements. It is to be appreciated, however, that the particular materials or combination of materials employed for base 28 and the base-positioning mechanism 68 may be chosen to achieve any desired performance characteristics.

In the illustrative embodiment shown in FIGS. 1-9, a quick-release mechanism 27 is shown that includes: a quick-release pin 59, a quick-release pull ring 47, a quick-release pin housing 60, a pin spring 72, and a nut 66. The quick-release mechanism 27 enables the rider to conveniently adjust the position of the base 28 through locking positions 24 along the length of the gliding-board rail 13. In one embodiment, the quick-release pin 59 has a quick-release pull ring 47 attached to it through a receiving hole in quick-release pin 59. The rider can pull upwards on the quick-release pull ring 47 to disengage the quick-release pin 59 from the gliding-board rail 13's lockable positions 24.

Using the quick-release pull ring 47, the quick-release pin 59 can then be lowered by the rider into its default position in one of gliding-board rail 13's lockable positions 24, with the quick-release pin 59's default position held flexibly in place by pin spring 72, which is located in the quick-release pin housing 60. As illustrated, the quick-release pin housing 60 is attached to base rail 17 utilizing nut 66. In one embodiment, the pin spring 72 is formed from a spring steel, although it may be formed from any suitable material including, but not limited to, stainless steel. As illustrated, the quick-release mechanism 27 is advantageously placed in well 35 so that the rider kneels on the base cushion member 36 and not directly on quick-release pin 59 for a more comfortable ride. It is to be understood that any suitable quick-release mechanism may be employed to achieve any desired convenience or performance characteristics, and that the quick-release mechanism is not limited to this embodiment. It is to be further understood that in other embodiments the retaining device 14 does not utilize a base cushion member, as other configurations are possible.

Using the base-positioning mechanism 68, the rider can adjust his or her position forward and backward along the length of the gliding board 12 to enhance the performance of the gliding board 12. Typically, this would mean a forward, or downhill, position for harder packed snow, so that the edge of the gliding board 12 can more effectively carve into the snow surface, and a backward, or uphill, position for powdery snow so that the front end of the gliding board 12 can more easily ride up and so better float over light snow. Since the rider is kneeling, he or she cannot lean backward or forward as much as a standing rider to lift or dive, respectively, the forward end of the gliding board 12. Consequently, a mechanism for adjusting the rider's position along the length of the gliding board 12 is especially advantageous for a kneeling rider. While advantageous, other embodiments of the retaining device 14 do not enable the rider to adjust his or her position along a portion of the length of the gliding board 12, and still further embodiments may utilize other suitable configurations for adjusting the rider's position along a portion of the length of the gliding board to achieve any desired performance characteristics.

In the illustrative embodiment shown in FIGS. 1-9, the gliding-board rail 13 is affixed to the gliding board 12 using screws 70 that are inserted through rail screw holes 51 to achieve an attachment similar to a conventional snowboard strap binding. It is to be understood that any suitable attachment configuration may be employed to affix the gliding-board rail 13 to the gliding board 12 including an adhesive or a combination of an adhesive and screws, and so the attachment is not limited to the particular configuration illustrated in this embodiment.

One desirable characteristic of the base 28 of the retaining device 14 (FIGS. 1-9) is its ability to be employed to secure a kneeling rider to any gliding board. In this regard, the embodiment shown in the figures employs a universal base 28 that is configured to be mounted to any type of gliding board, without requiring that the base be configured for use with a particular gliding board.

Another desirable characteristic of the retaining device 14 (FIGS. 1-9) is that it may be positioned on the surface of the gliding board 12 according to each rider's personal preference. For example some riders, who spend most of their time on hard-packed snow, may prefer a more forward position so the edge of the gliding board can be more aggressively carved into the harder snow. Other riders, who spend most of their time on soft powdery snow, may prefer a more rearward position so the front edge of the gliding board better climbs up and floats over the top of lighter snow.

In the illustrative embodiment shown in FIGS. 1-9, medial side stabilizer 18, lateral side stabilizer 19, and front stabilizer 20, are a single homogeneous piece that is affixed to the base 28 using screws that pass through the underside of base 28, and are threaded into receiving holes in medial side stabilizer 18 and lateral side stabilizer 19 at attachment points 29. Base cushion member 36 is affixed using an adhesive to the base 28 to ensure the portion of the rider's leg 52 does not come into contact with the base 28, which in this embodiment may cause discomfort. The stabilizers are advantageously configured to prevent a buildup of snow, ice, and other debris at the front of the retaining device 14, and support the rider's side and front positions on the base 28. In this embodiment, because the stabilizers are more rigid than the linkage systems, front 21a-21a and rear 22a-22a, the stabilizers can be more responsive than the linkage systems, front 21a-21a and rear 22a-22a, in transmitting the torsional forces exerted on them to the gliding board 12.

The medial side stabilizer 18, lateral side stabilizer 19, and front stabilizer 20 may be formed from any suitable material or combination of materials to achieve a desired combination of strength, stiffness, weight and the like. For example, the medial side stabilizer 18, lateral side stabilizer 19, and front stabilizer 20 may be formed from a substantially rigid material, such as carbon-reinforced plastic, glass-reinforced nylon, carbon-fiber reinforced nylon, polycarbonate, magnesium, stainless steel, titanium, hardened steel, hardened aluminum, thermoplastic polyurethane and the like. It is to be appreciated, however, that the particular materials employed for the medial side stabilizer 18, lateral side stabilizer 19, and front stabilizer 20 may be chosen to achieve any desired performance characteristics.

It is to be understood that while the stabilizer configuration illustrated in this embodiment is advantageous to achieve a desired degree of stiffness and/or torsional stability, a retaining device without stabilizers may be employed, or the stabilizers may be employed as two or more unique pieces made from one or more materials, or the stabilizers may be affixed using any suitable attachment configuration including adhesives, rivets, welding, bolts and the like, or the stabilizers may be integrally formed with the base 28 from one or more materials, or a configuration utilizing one or more stabilizers may be employed. Consequently, the particular configuration illustrated in this embodiment should not be construed as limiting.

The retaining device 14 has an upper portion that in one embodiment is the base cushion member 36. The retaining device 14 has a bottom portion that in one embodiment includes the base rail 17 and other aspects of the retaining device 14 that may be positioned on the same side of the base 28 as the base rail 17 in the illustrative embodiment shown in FIGS. 1-9. It is to be understood that the upper portion may be of any suitable configuration including, but not limited to, the base cushion member 36 configured at an incline that may range from 5 to 35 degrees with respect to the base 28 such that the base cushion member 36 is configured to slope from the rear end of base 28 to the front end of base 28.

It is to be further understood that any suitable structures, members and the like, or any combination thereof, may be utilized for the upper portion of the retaining device 14, and that the structures, members and the like may be made from any suitable material, or combination of materials, to achieve any desired performance or convenience characteristics. Consequently, the particular configurations illustrated in this embodiment should not be construed as limiting.

It is to be understood in one embodiment the bottom portion of retaining device 14 advantageously includes the base rail 17 and the gliding-board rail 13. While advantageous, any suitable configuration for the bottom portion of retaining device 14 may be utilized including, but not limited to, a shock-absorbing suspension system layered directly between gliding-board rail 13 and gliding board 12, or a shock-absorbing suspension system layered between base 28 and gliding board 12 without the employment of gliding-board rail 13 and base rail 17, or no shock-absorbing system with base 28 attached directly to gliding board 12. Consequently, the particular configurations illustrated in this embodiment should not be construed as limiting.

In the illustrative embodiment shown in FIGS. 1-9, a hook-and-loop material 37 is affixed using an adhesive to the underside of the front 20, medial side 18, and lateral side 19 stabilizers, and configured to engage the demountably attached stabilizer cushion member 56 employed on the underside of the front 20, medial side 18, and lateral side 19 stabilizers. It is to be understood that while this configuration is advantageous, stabilizer cushion member 56 may be employed in different regions of the retaining device 14, or may be affixed using any suitable attachment configuration from something as simple as a permanent adhesion to something as complex as sliding mounts that enable sundry sizes of removable cushion member to be slid in and out. Consequently, the particular configurations illustrated in this embodiment should not be construed as limiting,

In the illustrative embodiment shown in FIGS. 1-9, only one of the retaining devices 14 has been shown, but it is understood that in the illustrative configuration a pair of the retaining devices 14 will be used by the rider.

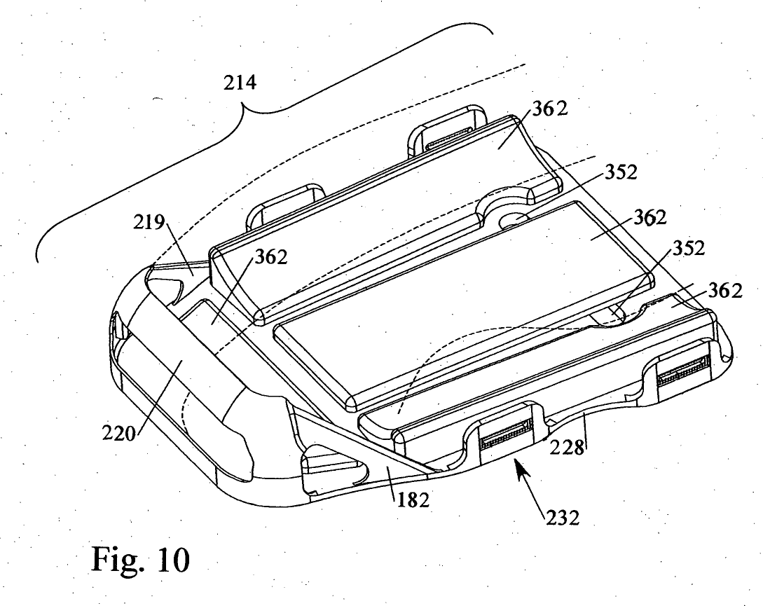

In another illustrative embodiment shown in FIG. 10, a retaining device 214 is shown that is identical to the retaining device 14 in the illustrative embodiment shown in FIGS. 1-9, except that the retaining device 214 is modified to support two of the kneeling rider's legs therein. Since the retaining device 214 is substantially identical to the retaining device 14, the retaining device 214 will not be discussed or illustrated in detail herein. Rather, the following description will focus mainly on the differences. Moreover, it will be apparent to those skilled in the art that most of the descriptions of the retaining device 14 apply to the retaining device 214.

In a manner that is substantially identical to the. embodiment shown above in FIGS. 1-9, the retaining device 214 of the illustrative embodiment shown in FIG. 10 includes a medial side located on the same side of the base 228 as a medial side stabilizer 182, a lateral side located on the same side of the base 228 as a lateral side stabilizer 219, a front end located on the same end of the base 228 as a front stabilizer 220, and a rear end located on the end of the base 228 that opposes the front end of the base 228.

The retaining device 214 of the illustrative embodiment shown in FIG. 10 utilizes a base-positioning mechanism (not shown) that is identical to the version of the base-positioning mechanism 68 of the illustrative embodiment shown in FIGS. 1-9, except that in the illustrative embodiment shown in FIG. 10 a pair of base-positioning mechanisms is utilized to support two of the rider's legs. Accordingly, the pair of base-positioning mechanisms of the illustrative embodiment shown in FIG. 10 will not be discussed or illustrated in detail herein.

Base 228 of the illustrative embodiment shown in FIG. 10 is identical to the version of base 28 of the illustrative embodiment shown in FIGS. 1-9, except that the base 228 has been widened to support two legs, and the base 228 includes a pair of wells 352 configured to engage the pair of base-positioning mechanisms. Accordingly, the base 228 will not be discussed or illustrated in detail herein.

The pair of wells 352 of the illustrative embodiment shown in FIG. 10 is identical to the version of the well 35 of the retaining device 14 of the illustrative embodiment shown in FIGS. 1-9, except that a paired configuration is utilized. Accordingly, the pair of wells 352 will not be discussed or illustrated in detail herein.

The pair of base-positioning mechanisms of the illustrative embodiment shown in FIG. 10 is affixed to the gliding board (not shown) utilizing an attachment configuration identical to the version utilized in the illustrative embodiment shown in FIGS. 1-9, except that a paired configuration is utilized. Accordingly, the attachment configuration for attaching the gliding board to the pair of base-positioning mechanisms of the illustrative embodiment shown in FIG. 10 will not be discussed or illustrated in detail herein.

The front stabilizer 220 of the retaining device 214 of the illustrative embodiment shown in FIG. 10 is identical to the version of the front stabilizer 20 of the illustrative embodiment shown in FIGS. 1-9, except that the front stabilizer 220 is wider to support two legs. Accordingly, the front stabilizer 220 of the illustrative embodiment shown in FIG. 10 will not be discussed or illustrated in detail herein.

The stabilizer cushion member (not shown) utilized under front stabilizer 220 of the retaining device 214 of the illustrative embodiment shown in FIG. 10 is identical to the version of the stabilizer cushion member 56 utilized under front stabilizer 20 of the illustrative embodiment shown in FIGS. 1-9, except that the stabilizer cushion member utilized under front stabilizer 220 is wider to support two legs. Accordingly, the stabilizer cushion member utilized under front stabilizer 220 of the illustrative embodiment shown in FIG. 10 will not be discussed or illustrated in detail herein.

The hook-and-loop material (not shown) of the illustrative embodiment shown in FIG. 10 positioned on the underside of the front stabilizer 220 is identical to the version of the hook-and-loop material 37 of the illustrative embodiment shown in FIGS. 1-9, except that it is wider to accommodate the increased width required by a pair of rider legs. Accordingly, the hook-and-loop material of the illustrative embodiment shown in FIG. 10 will not be discussed or illustrated in detail herein.

The retaining device 214 in the illustrative embodiment shown in FIG. 10 utilizes the identical front 21a-21a and rear 22a-22a linkage systems as utilized by the retaining device 14 of the illustrative embodiment shown in FIGS. 1-9, except that the front and rear linkage systems (not shown) utilized by the retaining device 214 have been slightly modified so that the front and rear linkage systems utilized by the retaining device 214 are greater in length to accommodate two of the rider's legs therein. Accordingly, the front and rear linkage systems of the illustrative embodiment shown in FIG. 10 will not be discussed or illustrated in detail herein. The base-attachment mechanism 232 of retaining device 214 is identical to the version of the base-attachment mechanism 23 of retaining device 14. Accordingly, the base-attachment mechanism 232 of the illustrative embodiment shown in FIG. 10 will not be discussed or illustrated in detail herein.

Having described several illustrative embodiments of the invention, various modifications and improvements will readily occur to those skilled in the art. Such modifications and improvements are intended to be within the scope of the invention. Accordingly, the foregoing description is by way of example only and is not intended to be limiting. The invention is limited only as defined in the following claims and the equivalents thereto.

What is claimed is:

1. A retaining device to secure a rider in a kneeling position to a gliding board for use on snow, the retaining device comprising:
a base that has a front end, a rear end, and a longitudinal axis extending between said front end and said rear end, said base having an upper portion and a bottom portion, said bottom portion being adapted to engage said gliding board,
said base provided to support a portion of the rider's lower body wherein said portion of the rider's lower body is a portion of one or both of the rider's legs, said portion of the rider's lower body extending along said longitudinal axis when said rider is retained by said retaining device;
at least one pair of linkage members supported on opposing sides of said base, said pair of linkage members for securing said portion of the rider's lower body to said base; and
at least one linkage engagement feature supported by at least one of said pair of linkage members, and being adapted to engage the other of said pair of linkage members, said linkage. engagement feature being movable between an open position to release said pair of linkage members, and at least one closed position to secure said pair of linkage members.

2. The retaining device according to claim 1, wherein said linkage engagement feature is a ratchet-type fastener so as to enable incremental adjustment of said linkage members.

3. The retaining device according to claim 1, further including a front-linkage system supported along the opposing sides of said base and a rear-linkage system supported along the opposing sides of said base, said front-linkage system and said rear-linkage system each comprising: said pair of linkage members, further included a third linkage member, and said linkage engagement feature.

4. The retaining device according to claim 1, wherein at least one of said pair of linkage members is configured so as to further include a linkage-length adjustment mechanism so as to enable adjustment of the linkage member's length.

5. The retaining device according to claim 1, further including a base-positioning mechanism so as to enable movement of said base through a plurality of lockable positions along a portion of the length of said gliding board.

6. The retaining device according to claim 1, further including a front stabilizer, a medial side stabilizer, and a lateral side stabilizer that are supported by said base, and positioned so as to support said rider's position on said base.

7. The retaining device according to claim 1, further including cushion members configured to extend across a portion of said base, said front stabilizer, said medial side stabilizer, and said lateral side stabilizer.

8. The retaining device according to claim 1, wherein said linkage engagement feature is hook and loop.

9. A retaining device to bind a rider in a kneeling position to a gliding board for use on snow, the retaining device comprising:
a base that is provided to support a portion of the rider's lower body wherein said portion of the rider's lower body is a portion of one or both of the rider's legs, said base having a front end and a rear end, and an upper portion and a bottom portion, said bottom portion configured to engage said gliding board, said upper portion configured at an incline with respect to said bottom portion sloping from said rear end to said front end;
at least one pair of linkage members being supported on opposing sides of said base, said pair of linkage members for securing said portion of the rider's lower body to said base; and
at least one linkage engagement feature supported by at least one of said pair of linkage members, and being configured to engage the other of said pair of linkage members, said linkage engagement feature being movable between an open position to release said pair of linkage members, and at least one closed position to secure said pair of linkage members,
and said linkage engagement feature being configured to move between an engaged position to maintain said pair of linkage members in said closed position, and a disengaged position to permit movement of said pair of linkage members to said open position.

10. The retaining device according to claim 9, wherein said linkage engagement feature is a ratchet-type fastener so as to enable incremental adjustment of said linkage members.

11. The retaining device according to claim 9, wherein said upper portion is configured at an acute angle with respect to said bottom portion.

12. The retaining device according to claim 9, further including a front-linkage system supported along the opposing sides of said base and a rear-linkage system supported along the opposing sides of said base, said front-linkage system and said rear-linkage system each comprising: said pair of linkage members, further included a third linkage member, and said linkage engagement feature.

13. The retaining device according to claim 9, wherein at least one of said pair of linkage members is configured so as to further include a linkage-length adjustment mechanism so as to enable adjustment of the linkage member's length.

14. The retaining device according to claim 9, further including a base-positioning mechanism so as to enable movement of said base through a plurality of lockable positions along a portion of the length of said gliding board.

15. The retaining device according to claim 9, further including a front stabilizer, a medial side stabilizer, and a lateral side stabilizer that are supported by said base, and positioned so as to support said rider's position on said base.

16. The retaining device according to claim 9, further including cushion members configured to extend across a portion of said base, said front stabilizer, said medial side stabilizer, and said lateral side stabilizer.

17. The retaining device according to claim 9, wherein said linkage engagement feature is hook and loop.

18. A retaining device to couple a rider in a kneeling position to a gliding board for use on snow, the retaining device comprising:
at least one linkage member being supported along a side of a base for coupling to said base a portion of the rider's lower body wherein said portion of the rider's lower body is a portion of one or both of the rider's legs;
at least one linkage engagement feature adapted to engage said linkage member and being supported along a side of said base opposing said side of said base supporting said linkage member, said linkage engagement feature configured to move between a locking position to maintain said linkage member in each of its plurality of closed positions, and a release position to permit movement of said linkage member to its open position,
said linkage engagement feature being movable to said locking position only when said linkage member is moved to the closed position; and
said base having an upper portion and a bottom portion, said bottom portion configured to engage said gliding board, said base provided to support said rider in said kneeling position, said base including a medial side and a lateral side, said base to receive said portion of the rider's lower body between the medial and lateral sides.

19. The retaining device according to claim 18, wherein said linkage engagement feature is a ratchet-type fastener so as to enable incremental adjustment of said linkage members.

20. The retaining device according to claim 18, wherein said linkage engagement feature is hook and loop.

21. The retaining device according to claim 18, wherein said linkage member is a strap.
